(19) United States
(12) Patent Application Publication
(10) Pub. No.: US 2010/0269450 A1
(43) Pub. Date: Oct. 28, 2010

(54) DOOR PANEL WITH THERMAL BREAK

(75) Inventor: Jonathan D. Thielmann, Delray Beach, FL (US)

Correspondence Address: LAHIVE & COCKFIELD, LLP;FLOOR 30, SUITE 3000, ONE POST OFFICE SQUARE, BOSTON, MA, 02109, US

(73) Assignee: Speyer Door and Window, Inc., Boca Raton, FL (US)

(21) Appl. No.: 12/578,113

(22) Filed: Oct. 13, 2009

Related U.S. Application Data
(60) Provisional application No. 61/172,865, filed on Apr. 27, 2009.

(51) Int. Cl. E04C 2/24; E06B 3/96

(52) U.S. Cl. 52/784.15; 52/656.4

(57) ABSTRACT

A door panel includes a frame, a laminate core, a plurality of thermally-insulative connectors, and an exterior skin. The frame defines a portion of an outer periphery of the panel and has an inner section and an outer section positioned, respectively, adjacent inner and outer portions of the panel. The laminate core is positioned between the inner section and the outer section of the frame. The plurality of thermally-insulative connectors connect the inner section and the outer section to the core. The exterior skin covers the frame. The core is a thermal barrier between the inner section and the outer section. The inner section and the outer section are formed from a thermally-insulative material. The core includes an inner layer formed from a thermally conductive material, and two outer layers formed from steel. The thermally-insulative connectors include a thermally-insulative jacket and a fastener positioned within the jacket.

### CROSS-REFERENCE TO RELATED APPLICATIONS

This application claims the benefit of U.S. Provisional Application No. 61/172,865, filed Apr. 27, 2009, which is incorporated herein by reference in its entirety.

### BACKGROUND OF THE INVENTION

1. Field of the Invention

The disclosure relates generally to door and window panels, and, more specifically, to panels having a thermal break for improved thermal performance of the panel.

2. Description of the Related Art

Many types of panels exists for doors and windows using common types of materials, such as aluminum, wood, steel, and composites thereof. However, each type of material has its own disadvantages/advantages. For example, while a material, such as aluminum, can be formed with high-dimensional tolerances, this material is thermally conductive, and as such, provides poor thermal resistance. Alternatively, other materials, such as wood or plastics, have better thermal resistance, these materials are not as strong as other materials.

New types of sealing/locking systems have been introduced with door panels, which require particular types of edge profiles of the panel, and these profiles cannot be easily provided by certain materials (e.g., wood).

There is, therefore, a need for a door panel that is able to provide the advantages of multiple types of materials in terms of penetration/impact resistance, thermal performance, and the ability to have intricate edge profiles.

### BRIEF SUMMARY OF THE INVENTION

Embodiments of the invention address deficiencies of the art with respect to effectively creating a thermally-efficient panel while providing penetration/impact resistance and the ability to have intricate edge profiles. For example, a panel includes a frame, a laminate core, a plurality of thermally-insulative connectors, and an exterior skin. The frame defines a portion of an outer periphery of the panel and has an inner section and an outer section positioned, respectively, adjacent inner and outer portions of the panel. The laminate core is positioned between the inner section and the outer section of the frame. The plurality of thermally-insulative connectors connect the inner section and the outer section to the core. The exterior skin covers the frame. The core is a thermal barrier between the inner section and the outer section. The inner section and the outer section are formed from a thermally conductive material. The core includes an inner layer formed from a thermally-insulative material, and two outer layers formed from steel. The thermally-insulative connectors include a thermally-insulative jacket and a fastener positioned within the jacket.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a front view of a panel in accordance with the inventive arrangements;

FIG. 2 is a cross-sectional, perspective view of the panel;

FIG. 3 is a cross-sectional view of the panel without a skin;

FIG. 4 is a cross-sectional view of the panel with a metallic skin; and

FIG. 5 is a cross-sectional view of the panel with a non-metallic skin.

### DETAILED DESCRIPTION OF THE INVENTION

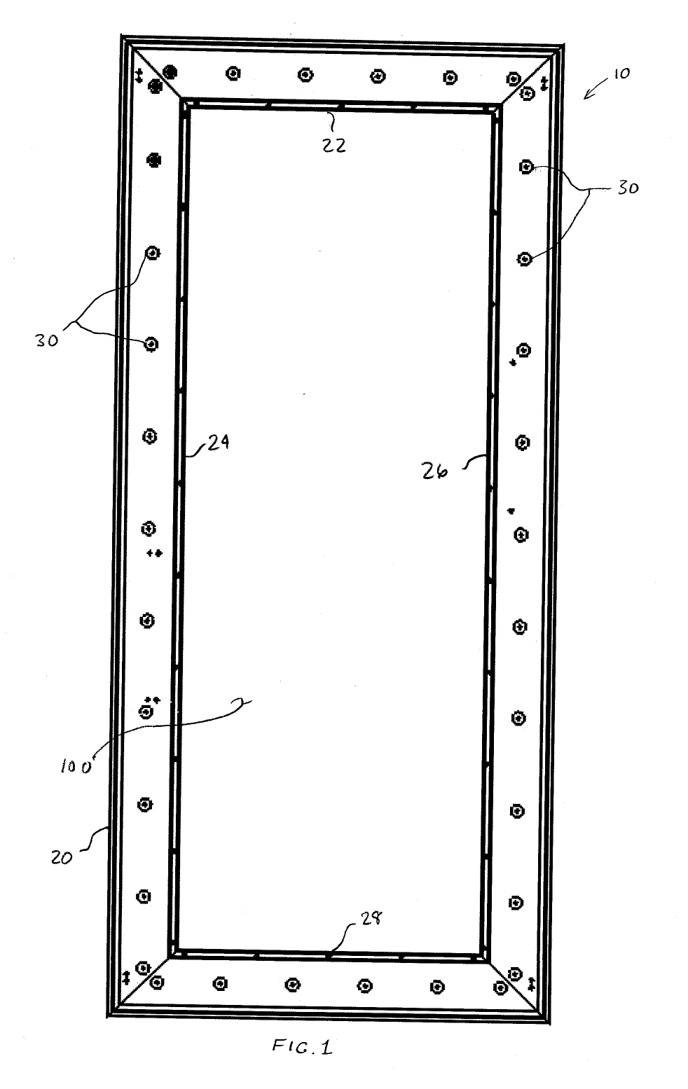

Referring to FIG. 1, an exemplar panel 10 for use with a door or window is illustrated. The panel 10 can be used with many types of doors and/or windows, such as pocket doors, sliding doors, French doors, entry doors, garage doors, sliding windows, single-hung windows, double-hung windows, casement windows, and awning windows. The panel 10 includes a frame 20 and core 100. Although the panel 10 is not limited in this manner, the frame 20 can define a portion of the outer periphery of the panel 10. Although not limited in this manner, the frame 20 can include separate portions such as a header rail 22, stile rails 24, 26, and a sill rail 28.

The frame 20 is not limited by the material used to the frame 20. For example, the frame 20 can be formed from fiberglass. However, in certain aspects of the panel 10, the frames are formed from an extruded aluminum. Forming the frame 20 from aluminum allows for both high-strength and reduced weight. Additionally, the frame 20 can be formed with an intricate edge profile 25 through, e.g., extrusion of the aluminum. By providing the capability to form intricate edge profiles 25, the panel can be used with new locking/sealing mechanisms.

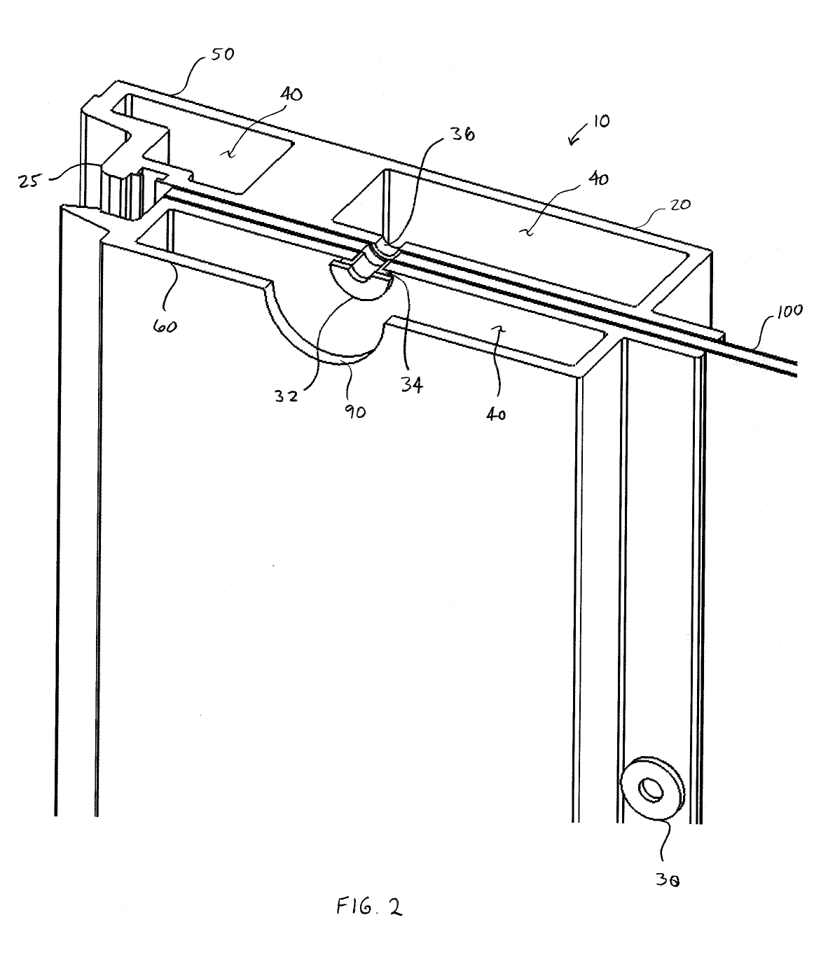

Referring to FIG. 2, a core 100 is sandwiched between the outer and inner portions 40, 50 of the frame 20. In certain aspects of the panel 10, the core 100 is configured as a break between the inner and outer portions 40, 50 of the frame 20 and the panel 10. For example, the core 100 can be configured as a thermal break. Additionally, the core 100 can be configured as a sound break that reduces the transmission of sound from one side of the panel 10 to another side of the panel 10. Still further, the core 100 can be configured as a physical break that structurally resists impacts against the panel 10 and/or the penetration of objects through the panel 10.

In certain aspects of the panel 10, the core 100 is formed from a single material, such as plastic, steel or glass. However, in other aspects of the panel 10, the core 100 is formed from multiple materials. Additionally, these multiple materials can be combined together, for example, as a laminate.

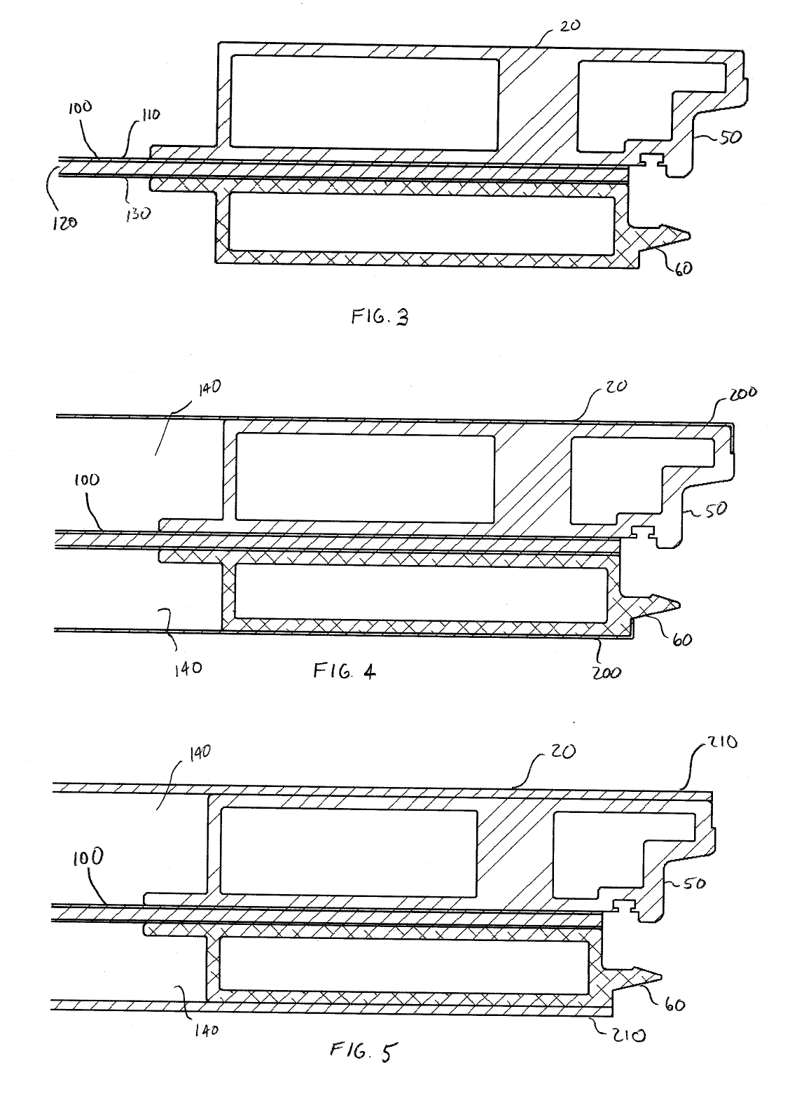

FIG. 3 illustrates an example in which a combination of different materials is used to form the core 100. In this particular aspect, a layer 120 of a thermally-insulative material, such as plastic (e.g., vinyl) or fiberglass, is sandwiched between two layers 110, 130 of a high-strength material, such as steel or aluminum. Since the thermal-insulative layer 120 separates the outer layers 110, 130, the core 100 can act as a thermal break. Additionally, the high-strength outer layers 110, 130 can act as a physical break that resists puncture. An alternate laminate, for example, could include a layer of high-strength material sandwiched between layers of a thermally-insulative material.

The panel 10 is not limited in the manner in which the core 100 is attached to the frame 20. However, in certain aspects of the panel 10, thermally-insulative connectors 30 are used to attach the core 100 to the frame 20. The thermally-insulative connectors 30 are configured to reduce the transfer of heat from one side of the panel 10 to the other side of the panel 10.

The panel 10 is not limited as to a particular type of thermally-insulative connector 30. However, in certain aspects the connector 30 includes a thermally-insulative jacket 34 through which a fastener 32, such as rivet, is positioned. For example, referring again to FIG. 3, the jacket 34 is positioned within a through-hole 36 that passes between the outer and inner portions 50, 60 of the frame 20 as well as the core 100. The jacket 34 can cover the thermally-conductive portions of the core 100, as well as the inner and outer portions 50, 60 of the frame 20.

The jacket 34 can also serve to thermally-isolate the fastener 32 from the thermally-conductive portions of the core 100, as well as the inner and outer portions 50, 60 of the frame 20. In this configuration, the thermally-insulative connector 30 is configured to both attach the core 100 to the outer and inner portions 50, 60 of the frame 20 as well as maintain a thermal break between the outer and inner portions 50, 60 of the frame.

Although not limited in this manner, the panel 10 may include access holes 90 within the frame 20. The access holes 90 are configured to permit access to the through-hole 36 into which the thermally-insulative jacket 34 is positioned.

Referring to FIGS. 4 and 5, the panel 10 is not limited as to a particular type of exterior skin 200, 210 covering the panel 10. For example, FIG. 4 illustrates the panel 10 being covered by a metal skin 200, such as steel. Alternatively, FIG. 4 illustrates the panel 10 being covered by a non-metallic skin 210, such as fiberglass. The manner by which the skins 200, 210 are connected to the frame 20 is not limited. For example, the skins 200, 210 may be connected to the frame 20 via welding, glue, and/or connectors.

To further reduce the transmission of sound and/or heat from one side of the panel 10 to another side of the panel 10, insulative material can be introduced into cavities 40, 140 within the frame and between the core and skin 200, 210, respectively. Materials capable of reducing the transmission of sound and/or heat are well known, and the panel 10 is not limited to any material so capable. For example, open or closed-cell foam may be introduced into the cavities 40, 140.

What is claimed is:

1. A panel for a door/window system, comprising:
a frame having an inner section and an outer section positioned, respectively, adjacent inner and outer portions of the panel; and
a core positioned between the inner section and the outer section of the frame, wherein
the core is a thermal barrier between the inner section and the outer section.

2. The panel of claim 1, wherein
the inner section and the outer section are formed from a thermally conductive material.

3. The panel of claim 1, wherein
the core is a laminate structure.

4. The panel of claim 2, wherein
the core includes
an inner layer formed from a thermally-insulative material, and
two outer layers formed from a high-strength material.

5. The panel of claim 4, wherein
the two outer layers are formed from steel.

6. The panel of claim 1, wherein
the frame defines a portion of an outer periphery of the panel.

7. The panel of claim 1, further comprising
a plurality of thermally-insulative connectors connecting the inner section and the outer section to the core.

8. The panel of claim 7, wherein
the thermally-insulative connectors include a thermally-insulative jacket and a fastener positioned within the jacket.

9. The panel of claim 8, wherein
the thermally-insulative jacket prevents physical contact between the fastener and the frame.

10. The panel of claim 8, further comprising
an exterior skin covering the frame.

11. The panel of claim 10, wherein
the exterior skin is formed from metal.

12. The panel of claim 10, wherein
the exterior skin is formed from a non-metallic material.

13. The panel of claim 1, further comprising
insulative material positioned within cavities within the panel.

14. A door panel, comprising:
a frame defining a portion of an outer periphery of the panel and having an inner section and an outer section positioned, respectively, adjacent inner and outer portions of the panel;
a laminate core positioned between the inner section and the outer section of the frame;
a plurality of thermally-insulative connectors connecting the inner section and the outer section to the core; and
an exterior skin covering the frame, wherein
the core is a thermal barrier between the inner section and the outer section,
the inner section and the outer section are formed from a thermally conductive material,
the core includes
an inner layer formed from a thermally-insulative material, and
two outer layers formed from steel,
the thermally-insulative connectors include a thermally-insulative jacket and a fastener positioned within the jacket.
